(19) United States
(12) Patent Application Publication
(10) Pub. No.: US 2014/0201296 A1
(43) Pub. Date: Jul. 17, 2014

(54) System and Method for Improving Messages

(71) Applicant: Zoosk, Inc., San Francisco, CA (US)

(72) Inventors: Martin Patfield, San Francisco, CA (US); Eric R. Barnett, Menlo Park, CA (US); Charles E. Gotlieb, San Francisco, CA (US)

(21) Appl. No.: 14/154,970

(22) Filed: Jan. 14, 2014

Related U.S. Application Data
(60) Provisional application No. 61/752,393, filed on Jan. 14, 2013.

(51) Int. Cl. H04L 12/58

(52) U.S. Cl. CPC H04L 51/04
USPC 709/206

(57) ABSTRACT

A system and method assists a user in composing more effective messages to a recipient based on experiences of successful messages sent to that recipient, other recipients having one or more similar characteristics as the recipient, or both.

### RELATED APPLICATION

This application claims the benefit of Attorney Docket Number 1754, U.S. Provisional Patent Application Ser. No. 61/752,393 entitled, “Method and Apparatus for Improving Messages” filed by Martin Patfield, Eric Barnatt, and Charles Gotlieb in Jan. 14, 2013 and is hereby incorporated by reference in its entirety.

### FIELD OF THE INVENTION

The present invention is related to computer software and more specifically to computer software for message composition.

### BACKGROUND OF THE INVENTION

Messages may be sent from one user of a web site to another user of the website. Facilities for sending messages are suboptimal. What is needed is a system and method for improved messaging.

### SUMMARY OF INVENTION

A system and method allows users to register to use a web site, and to provide profile information describing characteristics of themselves and preference information describing preferences for characteristics of other users with whom they would like to meet or otherwise interact. The system and method allows users to send messages to one another and to receive replies to those messages, and allows users who receive messages to reply to them. All such actions may be recorded with the date and time such action was taken.

The system and method analyzes the messages sent to users of each of one or more regions. A region may be strictly location-based (e.g. the United States or Canada or Europe), and/or may take into account other user characteristics, for example, all users within one region may be heterosexual male users in North America, with other types of users in North America considered to be excluded from that “region”, but such other types of users may be considered to be in a different region. As used herein a “region” is a set of one or more characteristics corresponding to a group of two or more users, and a user “in a region” is a user that has or is believed to have all of the one or more such characteristics.

The messages analyzed may include messages for which replies have been received and those for which replies have not been received after the message is viewed. Messages that have been viewed but not replied to within an average period of time (or an average plus an offset, such as two standard deviations from the average) that messages that do get replied to are replied to may be ignored by the analysis.

The analysis of such messages may be performed for messages sent to users of each region and may be performed for each of some or all users, for example, all users who have replied to a minimum number of messages. In one embodiment, messages sent to users who respond to a very high number of messages or a very low number of messages relative to other users in the region may be removed from the analysis of messages for a region.

Messages replied to (other than those described in the next parenthetical) are considered successful and messages not replied to (and optionally those replied to with replies of very short messages relative to all replies or those replied to with the replies containing certain words or phrases, such as “sorry” or “not interested”) are considered unsuccessful. In one embodiment, reply messages are not analyzed as messages themselves, but only as indicators of successful messages or unsuccessful messages and in another embodiment, they are. In still another embodiment, replies sent by the originator of a message may be analyzed. In one embodiment, either of such reply messages are analyzed separately from messages that are the initial message between two users, so that there may be an analysis for initial messages sent, a different analysis for first replies sent, and a different analysis for subsequent replies.

During the analysis of the messages, for each user and for all users in each region, words, phrases message lengths (within one of several discrete ranges of lengths) and message types for messages that are successful and unsuccessful are identified, and scores are assigned to each, positive for those contributing to success and negative for those not contributing to success, with those elements more frequently successful or unsuccessful having a higher absolute value than those less frequently successful or unsuccessful. In one embodiment, each such element has two scores, a positive score corresponding to the number of messages for which that element was successful and a negative score corresponding to the number of messages for which the element was not successful. Types of messages may include a) those identifying characteristics the sender and receiver have in common and b) those identifying characteristics of the sender that correspond to preferences of the recipient.

In one embodiment, a selectivity score is identified for each user based on the number of successful replies that user initiates. The selectivity score is assigned greater than one if the user tends to reply to a greater percentage of messages they receive than the average user in a way that would cause them to be marked successful, and less than one if the user tends to reply to less than the average percentage of messages. When identifying the all user score, users in the top and bottom few percentiles of such scores may be ignored.

Positive and negative weights for each of the above factors (words, phrases, length and types) or the individual elements of those factors (e.g. weights for individual words, phrases, message length ranges and types) are identified that, when multiplied by the corresponding positive or negative score for the word, phrase, message length range or type, or when multiplied by the sum of the scores for each factor, provide a higher positive resulting score for messages that have been successful than for those that have been unsuccessful, and provide a lower negative resulting score for messages that have been unsuccessful than for those that have been successful. In one embodiment, weights are identified for each word, phrase, length range and message type. In another embodiment, weights are identified for the sum of the scores of the elements of each factor (e.g. a single word weight that is used for the sum of all word scores).

In one embodiment, two additional weights are assigned: one used to weight the total score for all users and another that is used to weight the total score for the recipient user of a message if such score is unavailable (if only one weight is used, the weights may be considered to be assigned with an all users for the recipient's region weight of 100 and an individual user weight of 0). The weights indicate how well the “all users” score would have predicted the recipient user's response if the messages received by a user were scored as described herein, with a higher weight assigned to the all users score for those users whose actions are more accurately predicted by the weighted all users score for the recipient's region and a lower weight assigned the all users score for users whose actions are not predicted by the all users scores and for whom a sufficient amount of response data is available.

Some or all of the messages used to identify the scores and weights are analyzed using the scores and weights as described below to identify a total score for each message in each region, and N ranges of scores (e.g. N=5) are identified that group messages into 1/Nths of the total number of messages, by score, with the 1/N messages with the lowest score being assigned to the lowest range. N−1 thresholds that divide the ranges into equal number of messages are identified for each region. All of such information is stored for each of several regions and each of the users from which a sufficient number of replies have been received to allow for a meaningful analysis (e.g. 5 replies).

When a user requests to send a message to a recipient via a device, the device uploads the user identifier of the recipient to the server, the server identifies the region of the recipient using characteristics stored for that recipient, and the significantly successful and unsuccessful words and phrases, the message length ranges, the contribution scores for each of them (identified by summing the product of the positive score and the positive weight and the negative score and negative weight for that item), the words or phrases that indicate a message type and contribution scores for each message types, for the recipient user (if available) may be downloaded to the device, and, if not recently done within a threshold amount of time from the current date and time, similar information is downloaded from the server to the device for all users within the same region as the recipient, as well. The two additional weights are also downloaded to the device. The N−1 thresholds for the recipient's region are also downloaded, if they have not been downloaded within the threshold amount of time used above.

In one embodiment, the information uploaded corresponds to that identified for an original message in a thread, a first reply to a message in a thread, or a subsequent reply message in a thread, depending on how many messages the users have sent to one another in a thread. The device may indicate to the server an identifier of a message being replied to, to assist with this function.

The system and method analyzes on the device the user's message as it is being composed by the user. The message length is identified, any message types are identified by matching words or phrases corresponding to those downloaded for such types and optionally other words stored at the device. A total score is computed by summing the contribution scores for words, phrases or message types matched to the user's message and the contribution score for the current length of the message, both for all users and for that user if such information for the user is available. If both scores for all users and the recipient users are computed, they are multiplied by their respective two additional weights to compute a total score, or the all users score is used as the total score. In one embodiment, the selectivity score of the recipient user is downloaded with the other information and is used as a multiplier of the total score to increase or decrease it based on the selectivity of the recipient user.

An indicator is identified and displayed on the device next to the message that indicates which threshold range into which the total score falls, for example using a single red bar to indicate the score for the message is in the range between the lowest two thresholds, and one or more green bars to indicate the other threshold ranges, with more bars indicating a higher score.

In one embodiment, as the user is typing a message, the user may request hints to improve the message and obtain a higher score by clicking on a user interface element such as a button on the device or such a request is always considered to be made after each word is typed. The device analyzes the message and provides suggestions that will increase the total score of the message. For example, the device analyzes the words in the message and changes the color, as displayed to the user, of words or phrases that have a significant positive or negative contribution score. Contribution scores used may be those corresponding to the higher of the two additional weights, for example, using the contribution scores of all users for the region if the weight of the two additional weights for all users is higher than the weight for the recipient user. The system and method identifies the contribution score of the message types and suggests to the user that the user either add sentences corresponding to that type if its contribution score is significantly positive or remove them if the contribution score is significantly negative and may display some or all of the words or phrases downloaded for the two message types as suggested topics. The length of the message may be compared to the range with the highest contribution score and the user may be told to increase or decrease the length of the message so that the message length is in the highest scoring range.

The message may be sent by the device to the recipient user via the server, and processed as described above. Any number of users may send or retrieve messages using the server and a network, which may be wired or wireless, and may include a conventional Ethernet network or the Internet. The analysis used to provide scores and weights may be performed on the server and the analysis of the message being composed may be performed on the device and not vice versa.

### BRIEF DESCRIPTION OF THE DRAWINGS

FIG. 1 is a block schematic diagram of a conventional computer system.

FIG. 2, consisting of FIGS. 2A and 2B, is a flowchart illustrating a method of assisting a composer of a message in improving that message according to one embodiment of the present invention.

FIG. 3 is a block schematic diagram of a system for assisting a user of a message in composing that message according to one embodiment of the present invention.

FIG. 4 is a block schematic diagram of a server system of FIG. 3 shown in more detail according to one embodiment of the present invention.

FIG. 5 is a block schematic diagram of a representative user device of FIG. 3 shown in more detail according to one embodiment of the present invention.

### DETAILED DESCRIPTION OF A PREFERRED EMBODIMENT

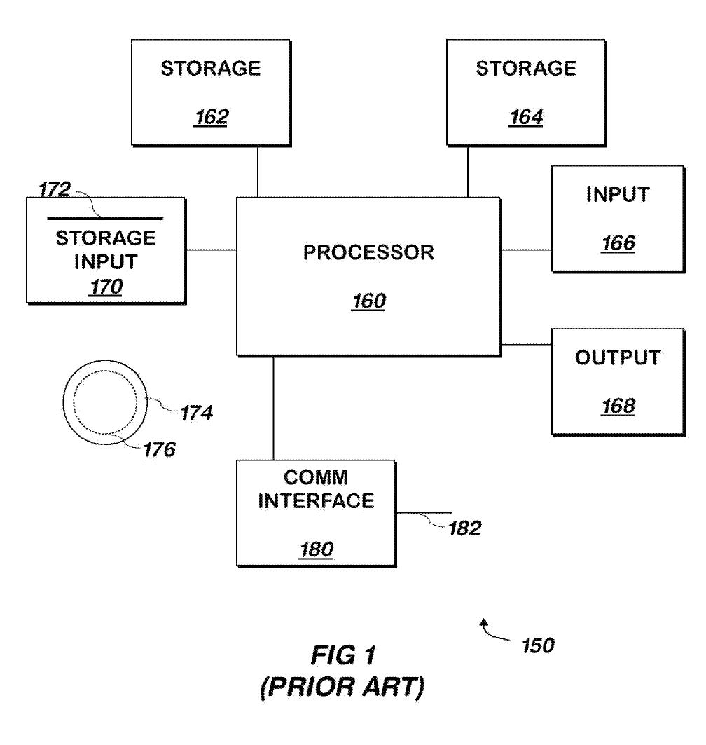

The present invention may be implemented as computer software on a conventional computer system. Referring now to FIG. 1, a conventional computer system 150 for practicing the present invention is shown. Processor 160 retrieves and executes software instructions stored in storage 162 such as memory, which may be Random Access Memory (RAM) and may control other components to perform the present invention. Storage 162 may be used to store program instructions or data or both. Storage 164, such as a computer disk drive or other nonvolatile storage, may provide storage of data or program instructions. In one embodiment, storage 164 provides longer term storage of instructions and data, with storage 162 providing storage for data or instructions that may only be required for a shorter time than that of storage 164. All storage elements described herein may include conventional memory and/or disk storage and may include a conventional database.

Input device 166 such as a computer keyboard or mouse or both allows user input to the system 150. Output 168, such as a display or printer, allows the system to provide information such as instructions, data or other information to the user of the system 150. Storage input device 170 such as a conventional floppy disk drive or CD-ROM drive accepts via input 172 computer program products 174 such as a conventional floppy disk or CD-ROM or other nonvolatile storage media that may be used to transport computer instructions or data to the system 150. Computer program product 174 has encoded thereon computer readable program code devices 176, such as magnetic charges in the case of a floppy disk or optical encodings in the case of a CD-ROM which are encoded as program instructions, data or both to configure the computer system 150 to operate as described below.

In one embodiment, each computer system 150 is a conventional SUN MICROSYSTEMS T SERIES SERVER running the SOLARIS operating system commercially available from ORACLE CORPORATION of Redwood Shores, Calif., a PENTIUM-compatible personal computer system such as are available from DELL COMPUTER CORPORATION of Round Rock, Tex. running a version of the WINDOWS operating system (such as XP, VISTA, or 7) commercially available from MICROSOFT Corporation of Redmond Wash. or a Macintosh computer system running the MACOS or OPENSTEP operating system commercially available from APPLE INCORPORATED of Cupertino, Calif. and the FIREFOX browser commercially available from MOZILLA FOUNDATION of Mountain View, Calif. or INTERNET EXPLORER browser commercially available from MICROSOFT above, although other systems may be used. Each computer system 150 may be a SAMSUNG GALAXY NEXUS III commercially available from SAMSUNG ELECTRONICS GLOBAL of Seoul, Korea running the ANDROID operating system commercially available from GOOGLE, INC. of Mountain View, Calif. Various computer systems may be employed, with the various computer systems communicating with one another via the Internet, a conventional cellular telephone network, an Ethernet network, or all of these.

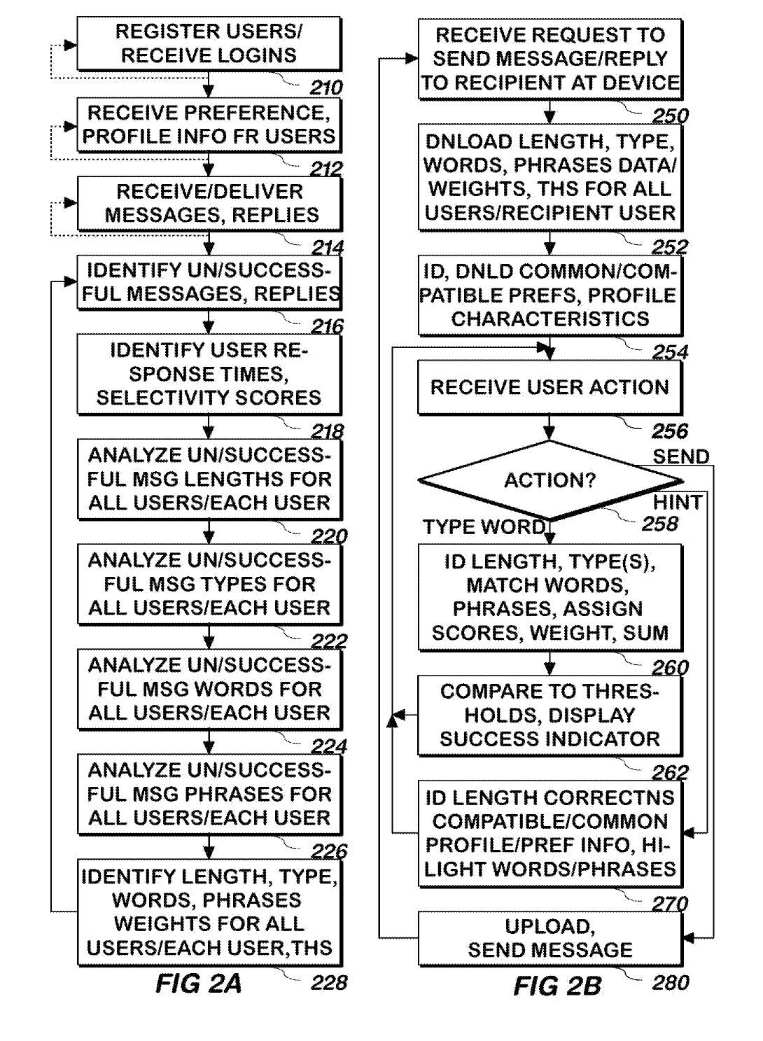

FIG. 2A is a flowchart illustrating a method for identifying values of factors, weights, and thresholds used to assist a user in composing an e-mail message according to one embodiment of the present invention.

Register Users And Receive Logins.

Referring now to FIG. 2A, users are registered and user logins are received 210. In one embodiment, any number of users may be registered via a website in a conventional manner, such as by receiving registration information from such user or users, including a user identifier and password. Log in information, including a registered user identifier and corresponding password may be received from any number of registered users at any time. The process of registering users and receiving user log ins may be an independently operating process as shown by the dashed line in the Figure.

Receive Preference, Profile Information From Users.

When a user has logged in, profile information and preference information corresponding to the logged in user may be received 212 from the logged in user. Profile characteristics corresponding to a user may include any of the user's physical characteristics, interests, activities and/or likes, as well as any photographs, location area information, such as the user's country, region information, or any other information. In one embodiment, all users within one or more defined location area, for example all registered users from one country, may be defined as a pool of “all users” for each user in the pool, or any other profile characteristics or preference information corresponding to users may be used to define the pool of all users. “All users” may be users within one “region”, which may be a location region, or a region based on other profile characteristics provided by the user, such as gender and/or sexual preference. For example, a pool of all users may be defined as the pool of all heterosexual male users living in southern California. Any number of regions or pools of all users may be defined using any number of profile characteristics, preference information, or combination of profile characteristics and/or preference information.

Preference information corresponding to a user may include any characteristics, interests, activities, likes, etc., that are desirable to the user in another user with whom the first user may wish to interact, such as by exchanging emails and/or meeting in person and/or in any other manner.

Receive/Deliver Messages And Replies.

At step 214, any messages, such as electronic mail messages, and/or replies to such messages from one user (“sending user”) to a second user (“recipient” or “intended recipient”) are received from the sender and delivered to the intended recipient as described in more detail below with respect to FIG. 2B. In one embodiment, any messages or replies sent from one user to another user may be stored, along with the date and time when such message was sent and the user identifiers corresponding to the sending user and the recipient user, and messages may be delivered to the user specified as the intended recipient in a conventional manner, such as by notifying such intended recipient user that he or she has received a message and allowing the user to log in and view such received message. In one embodiment, any message or reply to a message which is viewed by the user for whom such message or reply is intended may be marked as viewed, along with the date and time when such message is first viewed.

In one embodiment, a reply message may be any message sent from the recipient of a first message to the sender of such first message in direct response to the first message sent from the sender to the recipient. When a reply is sent corresponding to any message, the first message for which such reply message is sent may be marked as replied to, along with the date and time when the reply message is sent, and the reply message received, stored, and delivered may be marked as a response to the first message.

In one embodiment, the process of receiving and delivering messages and replies may be an independently operating process as shown by the dashed line in the Figure.

Identify Successful And Unsuccessful Messages And Replies.

Successful and unsuccessful messages and replies are identified 216. In one embodiment, any message or reply message which has been viewed by the intended recipient and has been replied to by the recipient may be identified as a successful message. Messages and/or replies which are viewed by the intended recipient but not replied to by the recipient via a reply message may be identified as unsuccessful messages. In one embodiment, messages which have been replied to by the recipient with very short reply messages (e.g. two words), or replied to with certain courtesy messages expressing that the recipient is not interested in responding to such message, and/or messages which have been viewed by the recipient may also be identified as unsuccessful messages.

In one embodiment, messages which have not been viewed by the intended recipient may not be identified as successful or unsuccessful. In one embodiment, messages received from users whose profile characteristics, for one or more specified characteristics, are outside or very far from the recipient's preferences are not identified as successful or unsuccessful. For example, a message from a male sent to a heterosexual male may not be identified as successful or unsuccessful.

Identify User Response Times And Selectivity Scores.

A standard response time may be identified for each user and for all users based on the amount of time it takes each user and all users to respond to any received message once it has been viewed, and a selectivity score may be identified for each user receiving messages 218. In one embodiment, to identify a standard response time for each user, the amount of time, for example in days and/or hours, between when a user views a received message to when that user sends a reply corresponding to such viewed message, if the user sends any reply message, may be identified corresponding to each of any messages received by the user, and an average or a mean of any such identified response times may be identified as the standard response time for such user.

In one embodiment, any unsuccessful messages which have been viewed by the recipient user, and which have not been replied to by the recipient user, but for which standard response amount of time corresponding to such recipient user has not yet passed since the recipient user viewed the message may not be identified as successful or unsuccessful, and such message and any data corresponding to such message, described below, may be excluded from any analysis of successful and unsuccessful messages as described below. In one embodiment, a standard response time may not be identified for users who have received zero messages, and/or viewed zero messages, and/or replied to zero messages, and any such user for which no standard response time is identified may be excluded from the pool of all users described herein.

Additionally as part of step 218, one or more selectivity scores may be determined for each user based on any number of selectivity factors such as the number of messages the user receives and/or views, and/or the percentage of such received messages to which the user responds to by sending a reply message, and any other factors. Based on whether such score or scores falls below or exceeds one or more thresholds, message data corresponding to each user may or may not be included in the analysis of successful and unsuccessful messages of all users, as described in more detail below. In one embodiment, message data, described below, corresponding to the most selective and the least selective users may also be omitted in the message data analysis described below. For example, users receiving very few messages, and/or users responding to a very high percentage of messages received, and/or users responding to a very small portion of messages received may not be included in the pool of all users described herein.

Analyze Successful and Unsuccessful Lengths for all Users/Each User.

The lengths of successful messages are analyzed, and the lengths of unsuccessful messages are analyzed for each user, as well as for each pool of all users 220. Analysis of messages is performed with respect to the recipient of the message. To analyze the length of successful and unsuccessful messages, any number of ranges corresponding to the length of successful messages may be defined, which may be pre-determined ranges for message length and/or ranges for message length identified via the analysis described herein, and a helpful score and an unhelpful score may be identified corresponding to each of such defined ranges for message length. In one embodiment, the helpful score corresponding to each range of message lengths may be determined by identifying the length of every message which has been identified as successful, such as by identifying the number of words (or lines, or sentences) included in each successful message, and a success counter corresponding to the appropriate range of message lengths may be incremented (from zero) for each successful message identified as being within that range of lengths.

In one embodiment, an unsuccessful message counter corresponding to the same defined ranges of message lengths may be incremented corresponding to the appropriate range of lengths for each unsuccessful message identified as being within such range of lengths. The unhelpful score corresponding to each defined range of message lengths may be identified as the negative of the value of such unsuccessful message counter corresponding to each range. In one embodiment, the helpful score corresponding to each range of lengths defined for message length may be identified as a positive score, and the unhelpful scores for message length may be identified as negative scores.

Such data corresponding to successful and unsuccessful message lengths may be analyzed, and helpful scores and unhelpful scores may be calculated corresponding to message length, for messages corresponding to each recipient user, excluding any messages identified as neither successful or unsuccessful for the recipient user as described above. Such data corresponding to message length may also be analyzed for messages corresponding to each of any pools of all users, excluding any users within each region identified as very selective or very not-selective based on the selectivity scores assigned to each user as described above, and a helpful score and unhelpful score corresponding to each defined range of message lengths may be calculated for all such pools of users.

For example, three ranges for message length may be identified as 0-40 words (Range A), 41-200 words (Range B), 200+ words (Range C). To analyze message length data corresponding to one user, the length of any messages received and viewed by the user may be identified, and the appropriate success and unsuccessful message counters corresponding to each defined range may be incremented as described. If a user has viewed five messages and replied to two of such messages which were of length 175 words and 200 words, and not replied to three of such messages, which were of length ten words, 36 words, and 1000 words, then the helpful scores and unhelpful scores for such user corresponding to message length may be calculated as: 0 and −2 for Range A, 2 and 0 for Range B, and 0 and −1 for Range C.

For 10,000 messages corresponding to the pool of all users corresponding to the user, if 100 successful messages are identified as being of length 0-40 words, and 3500 unsuccessful messages are identified as being of length 0-40 words, then the helpful score and unhelpful score corresponding to Range A may be identified as 100 and −3500.

Analyze Successful and Unsuccessful Message Types for All Users/Each User.

Message content included in successful and unsuccessful messages may be analyzed to identify successful message types and unsuccessful message types corresponding to each user as well as all users 222. Any number of message types may be defined in any manner. In one embodiment, examples of messages types may include shared characteristic messages, incompatible characteristics messages, compatible match messages, incompatible match messages, generic messages, and any other type of messages. A shared characteristics message may be defined as any message from a sending user to a recipient user in which common interests, likes, and or other profile characteristics information is referenced. Such referenced information is that which is referenced in the message and which is included in both the profile characteristics corresponding to the sending user and the recipient user. For example, if “love dogs” is included in both a sending user's and recipient user's profile characteristics, and the sending user sends a message to the recipient user which includes a reference to the sending user's dog, then such message, which may be successful or unsuccessful, may be identified as a shared characteristic message.

In one embodiment, incompatible characteristics messages may be messages which reference profile characteristics corresponding to either the sender or the recipient, if such referenced profile characteristic information is incompatible or not included in the other user's characteristic information. For example, if a sending user's reported interests include television shows, beer, watching sports, and playing video games, and a recipient user's reported interests include wine, fine dining, hiking, skiing, and scuba diving, and do not include television shows, beer, watching sports or playing video games, then any message from the sending user to the recipient user which references television shows, beer, and/or video games may be identified as an incompatible interests message.

In one embodiment, compatible match messages may include any messages sent from a user whose profile characteristics match the preference information provided by the recipient of the message, if the message sent from the sender to the recipient references any such matched preference information. Incompatible match messages may include any messages sent from a sender whose profile characteristics are not a good match with the recipient's preference information, and/or any messages which reference any of such poorly matched preference information. For example, if the recipient user is a female user in her early thirties who prefers tall, younger male users with no children, then a message from a 28-year-old male user which references going hiking with his dog may be identified as a compatible match message. A different message to the same recipient user received from a 47-year-old male user which references his dog playing with his two children, may be identified as an incompatible match message.

In one embodiment, if shared characteristic messages, or messages in which the sender references interests or likes or other profile characteristics included in both the sender's and recipient's profile characteristics information, are frequently identified among messages which are identified as successful for the recipient user, then a high successful score may be calculated for such shared characteristic message type for such user. If such shared interest message type is identified frequently among successful messages corresponding to all users included in the pool of all users, then the successful score for such message type may also be high for messages corresponding to all users.

In one embodiment, messages in which the sender does not reference any specific interests, likes, or any other information included in the recipient's profile information or preference information may be identified as generic messages. If generic type messages frequently do not cause the recipients of such messages to send a reply message in response, then generic type messages may be scored highly as unsuccessful for each of such recipient users, as well as potentially for all users, if such generic messages are frequently not replied to by all users.

Any number of message types may be defined, and helpful and unhelpful scores corresponding to each defined message type may be calculated in a manner similar to the manner in which helpful and unhelpful scores are calculated corresponding to each defined range of message lengths described above. Such helpful scores and unhelpful scores may be calculated corresponding to each recipient user, as well as corresponding to each pool of all users. Scores for “all users” described herein are identified for all groups of “all users”.

Analyze Successful and Unsuccessful Message Words for All Users/Each User.

At step 224, any message words included in successful and unsuccessful messages are analyzed for each user and for all users. A helpful score and an unhelpful score may be calculated corresponding to each of any words identified in any successful and/or unsuccessful messages in a manner similar to the manner in which helpful scores and unhelpful scores are calculated corresponding to each range of message lengths and each defined message type above. For example, if the word “hot” is included in 500 successful messages, and included in 3500 unsuccessful messages, then the helpful and unhelpful scores corresponding to the word “hot” may be calculated as 500 and −3500. If a word “fun” is included in 2000 successful messages as well as in 2000 unsuccessful messages, then the helpful and unhelpful scores corresponding to “fun” may be calculated as 2000 and −2000.

In one embodiment, message words may be parsed in order to identify individual words included in messages, and words that appear equally proportionately frequently in both successful and unsuccessful messages may not be scored in the analysis of messages words, such as very commonly used words including, for example words that are pronouns (e.g. he, she, it, etc.), articles (e.g. the, a), conjunctions (e.g. and, but), and/or any other words.

Analyze Successful And Unsuccessful Message Phrases for all Users/Each User.

Message phrases included in successful messages and message phrases included in unsuccessful messages may be defined (and/or identified) and analyzed corresponding to each user, as well as corresponding to all users, and a helpful score and unhelpful score may be calculated corresponding to each of any defined message phrases 226. In one embodiment, helpful scores and unhelpful scores corresponding to message phrases may be calculated for any number of message phrases identified and/or defined in successful and unsuccessful messages in a manner similar to the manner in which successful and unhelpful scores corresponding to message length and message words are calculated above.

In one embodiment, message phrases may identified in successful or unsuccessful messages which include one or more message words which have been identified in successful and unsuccessful messages as part of step 224 above. In such an embodiment, the helpful and unhelpful scores calculated corresponding to any such message phrases may be calculated independently of the helpful and unhelpful scores calculated corresponding to the message words included in such message phrases. For example, if the message word “hot” is included in one or more messages phrases, such as in the phrases “it's hot” and “you′re hot”, then the successful and unhelpful scores corresponding to message phrases may be calculated for the phrases “it's hot” and “you′re hot” independently of any successful and unhelpful scores corresponding to message words calculated for the word “hot”. A phrase may be any set of two or more adjacent or otherwise nearby words not separated by punctuation in one embodiment.

Identify Weights and Thresholds for Message Length, Type, Words, and Phrases for all Users/Each User.

Weights are identified corresponding to helpful and unhelpful scores calculated with respect to message length, message type, message words, and message phrases, for each user and for each pool of all users, and one or more success indicator thresholds corresponding to a success indicator scores may be identified for each user and for each pool of all users 228.

In one embodiment, weights may be identified corresponding to each helpful score and unhelpful score corresponding to each type of message component (e.g. message length, type, words, and phrases), and/or weights may be identified corresponding to each helpful score and unhelpful score corresponding to each defined range, type, word, or phrase within each type of message component. For example, weights may be identified corresponding to the helpful score and unhelpful score corresponding to all message words identified in any successful and unsuccessful messages, or weights may be identified for each of the helpful scores and unhelpful scores corresponding to each message word identified in any successful and unsuccessful messages.

In one embodiment, weights may be calculated for one user by analyzing the successful and unsuccessful messages received by such user using conventional regression analysis to maximize the success indicator scores for successful messages received by such user and minimize the success indicator score for unsuccessful messages received by the user. Weights may be calculated for each pool of all users by analyzing the successful and unsuccessful messages received by each of the users included in each pool of all users to maximize the success indicator scores for successful messages and minimize the success indicator score for unsuccessful messages received by any of such users included in such pool of all users.

In one embodiment, the success indicator score corresponding to one user or to one pool of all users may be calculated by multiplying the helpful and unhelpful scores calculated corresponding to successful and unsuccessful messages received by the user, or received by the pool of all users, by the weight assigned to such component, for the user or for all users, and summing such weighted helpful and unhelpful scores. Regression analysis to maximize such success indicator scores corresponding to successful messages and minimize such success indicator scores corresponding to unsuccessful messages may be used to identify each of the weights corresponding to helpful and unhelpful scores for the user and for the pool of all users as described in more detail below.

Additionally as part of step 228, one or more success indicator ranges and/or thresholds may be identified by corresponding to success indicator scores. In one embodiment, four threshold values may be identified to define five score ranges: Range 1 may be identified as the range including all scores below the first threshold value; Range 2, all scores between the first threshold value and the second threshold value; Range 3, all scores between the second and third threshold values; Range 4, all scores between the third and fourth threshold values; and Range 4, may include all scores above the fourth threshold value. In one embodiment, such threshold values and/or ranges may be identified such that the number of messages for which the success indicator score falls within each range is equal or nearly equal.

For example, if 10,000 total successful and unsuccessful messages are analyzed, then the success indicator score corresponding to the 2000^{th} highest success indicator score may be identified as the first threshold, the 4000^{th} highest success indicator score may be identified as the second threshold, the 6000^{th} highest success indicator score may be identified as the third threshold, and the 8000^{th} highest success indicator score may be identified as the fourth threshold.

The method may repeat at step 216 periodically. Steps 216-228 are performed for each region.

Receive Request to Send Message/Reply to Recipient.

FIG. 2B is a flowchart illustrating a method of determining a likelihood of success corresponding to a message and displaying an indication of such likelihood according to one embodiment of the present invention. Referring now to FIG. 2B, at any time, a request may be received via a user device from a registered and logged in user to compose and send a message to another user or to reply to a message received from another user 250.

Upload Thresholds for all Users and Recipient User, and Download Data and Weights for Message Length, Type, Words, and Phrases for all Users and Recipient User.

Data analyzed and weights calculated corresponding to any number of message components, including message length, type, words, and/or phrases identified in successful and unsuccessful messages, as described above with respect to FIG. 2A, received by the intended recipient of the requested message, as well as in successful and unsuccessful messages received by the pool of all users corresponding to the intended recipient, are downloaded to the device of the user requesting to send the message 252. In one embodiment, data and weights corresponding to any message component may include the weighted helpful and unhelpful scores calculated corresponding to each component (or the sum of such values for one component) and the value of each component to which such score corresponds. For example, message words, and message phrases, and corresponding score for each may be downloaded, along with scores for message types and message lengths. In one embodiment, scores and values for the pool of all users corresponding to the intended recipient of the user's message may only be downloaded occasionally, for example if information corresponding to the same pool of all users has been previously downloaded within a threshold amount of time, such as if the user has recently sent a message to any recipient user within the same pool of all users as the intended recipient of the user's message. Scores and values for the intended recipient may be downloaded each time the user requests to send a message to such intended recipient.

In one embodiment, similarity weights may be identified for the data and weights corresponding to the intended recipient and for the data and weights corresponding to the pool of all users, and such similarity weights are downloaded to the user device. If the data and weights identified corresponding to the intended recipient of the message are similar to the data and weights identified corresponding to the pool of all users as described above, then a higher similarity weight may be assigned to the data and weights corresponding to the pool of all users. If the data and weights corresponding to the recipient user are not very similar to the data and weights corresponding to all users, then the recipient user's data and weights may be weighted with a higher similarity weight than the data and weights corresponding to the pool of all users. If a recipient user's analyzed propensities do not closely match propensities analyzed corresponding to all users, for example, if the helpful and unhelpful scores corresponding to message words “pretty” and “fun” are 0 and −5, and 1 and −4, respectively, for a recipient user, and 4000 and −200, and 4250 and −300 for the pool of all users, then similarity weight assigned to the recipient user's data and weights (e.g. 0.80) may be greater than the similarity weight assigned to the pool of all users' data and weights (e.g. 0.20).

In one embodiment, if the intended recipient of the user's message has not previously replied to a threshold number of messages, then the similarity weights assigned to such recipient user's data and weights and the data and weights corresponding to such recipient user's pool of all users may be 0 and 1, respectively.

In one embodiment, the intended recipient's selectivity score or scores may also be downloaded, and a score multiplier corresponding to such selectivity score or scores may be assigned to increase or decrease a display indicator score corresponding to the user's message, as described in more detail below.

Identify Common and/or Compatible Preferences and Profile Characteristics.

Any profile characteristics information corresponding to the user sending the message and the intended recipient of the message may be downloaded to the user's device, and any shared profile characteristics corresponding to both users, and/or any profile characteristics of the sending user which matches preference information corresponding to the intended recipient of the message may be identified 254.

In one embodiment, if the calculated weights corresponding to message type, including the similarity weights calculated for the user's data and weights and all users' data and weights, are relatively small weights (i.e. the message type may not highly influence the success indicator score corresponding to messages), or if no weights corresponding to message type have been calculated, then such common profile characteristics and matched preference information may not be downloaded or identified, and step 254 may be skipped.

Receive User Action.

Any user action may be received 256. In one embodiment, any number of actions, including the user typing message words, requesting hints to increase the probability of receiving a reply message, sending the message, or any other actions may be received. The user may type message words in any conventional manner, such as by using the user's keyboard or other input device at the user's device. In one embodiment, hints corresponding to any message components including message length, message type, message words, and/or message phrases may be requested by the user for his or her message, such as by hovering the cursor of the user's pointing device over words that have been highlighted as described below, or by clicking one or more help buttons to request such help.

If User Types Word, then Identify Message Length and Type(S), Match Message Words, Phrases, and Assign Score, Weight, and Sum.

If the action received from the user is the user typing words into the body of the e-mail message 258, then the length and type of the message may be identified, message words and/or phrases typed by the user may be matched with any message words and/or phrases defined for the user and/or for all users, and one or more sets of weighted helpful and unhelpful scores (or a sum for each of such sets) corresponding to each of such message components may be identified corresponding to the length and type of the user's message and the message words and phrases included in the user's message. In one embodiment, weighted helpful and unhelpful scores corresponding to a message component, or the helpful and unhelpful scores corresponding to such component multiplied by their respective assigned weights as described above, may be downloaded to the user's device as part of step 252 above, or they may be calculated by the user's device.

A success indicator score may be calculated corresponding to a message by summing the weighted helpful and unhelpful scores corresponding to each of the message components identified in the message. In one embodiment, the weighted helpful and unhelpful scores downloaded corresponding to the recipient user may be used to determine a success indicator score for the user's message with respect to the recipient user, and the weighted helpful and unhelpful scores downloaded corresponding to all users may also be used to calculate a second success indicator score for the user's message with respect to the pool of all users. Each success indicator score may be multiplied by the respective similarity weights assigned to the recipient user's data and weights and to the data and weights corresponding to the recipient user's pool of all users, and the two weighted success indicator scores are added together to determine a display indicator score corresponding to the user's message.

In one embodiment, the selectivity score or scores downloaded corresponding to the intended recipient of the user's message may be used to determine a multiplier for the display indicator score calculated corresponding to the user's message. In one embodiment, a multiplier to increase the display indicator score corresponding to the user's message may be determined if the selectivity score or scores downloaded corresponding to the recipient user are very low (i.e. intended recipient is not very selective and responds to a very high percentage of messages received), and a multiplier may be assigned to decrease the display indicator scores corresponding to the user's message if the selectivity score corresponding to the recipient user is very high (i.e. intended recipient is very selective and responds to a very low percentage of messages received).

Compare to Thresholds and Display Success Indicator.

The display indicator score calculated corresponding to the user's message is compared to the success indicator thresholds identified as described above, and a success indicator is displayed corresponding to the display indicator score identified for the user's message 262. In one embodiment, the success indicator may be displayed as a number of green or red bars, with one or more red bars indicating a low probability of success corresponding to the user's message, and one or more green bars indicating varying higher probabilities of success corresponding to the user's message. In one embodiment, a higher number of green bars may be displayed for messages for which a higher probability of success has been determined, with one green bar indicating a lower probability of success than two green bars.

In one embodiment, if the display indicator score corresponding to the user's message falls within the first range of success indicator scores identified above, then the success indicator displayed to the user corresponding to the user's message may be displayed as one red bar. If the display indicator score corresponding to the user's message is determined to be within the second range of scores identified for success indicator scores, then the success indicator displayed to the user may include two green bars, and so on and so on. The ranges are defined by one, or two, successive thresholds, with the lowest and highest range being below or above the lowest or highest thresholds, respectively.

The method may continue at step 256.

If User Requests Hint, then Identify Length Corrections, Common/Compatible Preference/Profile Information, and Highlight any Unsuccessful Words.

If the user requests any hint 258, such as by hovering the cursor of the user's pointing device over any message words or phrases which the user has typed, or by clicking a user interface control to request help, such as a help button, then any length suggestions, and/or message type suggestions, and/or message word suggestions, and/or message phrase suggestions may be identified, and any such identified suggestions may be provided to the user 270.

In one embodiment, to provide length suggestions, the length of the user's message may be compared to the defined ranges of message lengths scored using successful and unsuccessful messages received by the recipient user, as well as the successful and unsuccessful messages received by all users, and a length suggestion may be identified corresponding to the user's message if the user's message is not included in the most ideal range of lengths corresponding to successful messages. For example, the length with the highest score for all users and for the recipient user may be displayed to the sending user along with the current length of the message, with an indication to lengthen or shorten the current message to conform with the one or both ranges. Such suggestion may be displayed to the user as an indication that the user's message is too long or an indication that the user's message is too short, or in any other manner.

In one embodiment, if the message type corresponding to the user's message is not the most ideal message type corresponding to successful messages received by the user, and/or successful messages received by all users, then any number of corrections or suggestions may be displayed to the user, such as by displaying similar profile characteristics between the user composing the message and the intended recipient of the message, or by displaying matched preference information corresponding to the recipient user, or by highlighting, such as in a red color, any incompatible profile characteristics or unmatched preference information corresponding to the recipient user, or in any other manner.

In one embodiment, any message words and/or phrases identified in the user's message which have been identified frequently (e.g. have high scores) in unsuccessful messages received by the recipient user and/or received by all users may be highlighted, for example using a red color, to indicate that such highlighted words and/or phrases do not typically contribute to successful messages.

The method continues at step 256.

If User Sends Message, then Upload and Send Message.

If the user sends the message, then such message is uploaded and stored along with the date and time, the user identifier of the sender, and the user identifier or the intended recipient, as described above, and the intended recipient of the message is notified as described above 280.

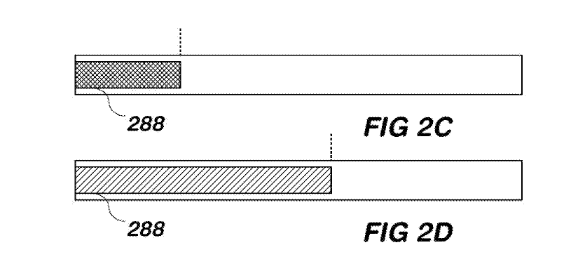

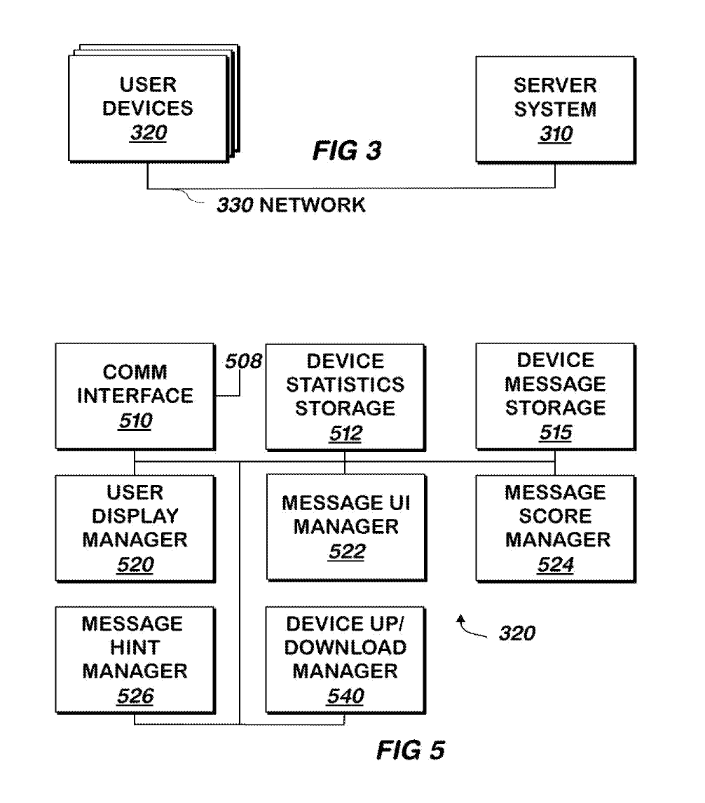

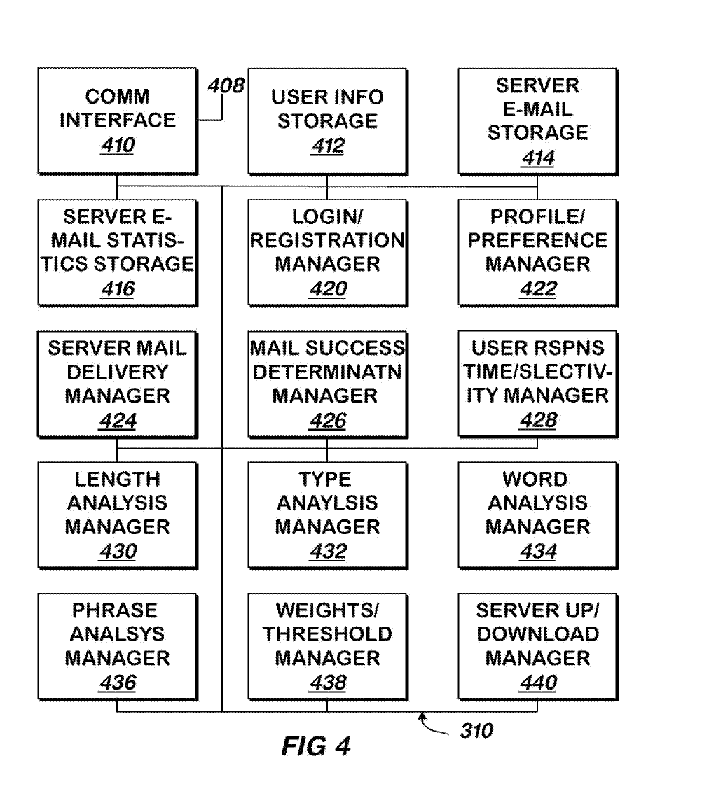

FIG. 3 is a block-schematic diagram of a system for assisting a user in sending a message. In one embodiment, the system of FIG. 3 contains server system 310 (shown in more detail in FIG. 4) and any number of user devices 320, though other arrangements may be used. Server system 310 and user devices 320 (shown in more detail in FIG. 5) operate as described herein and communicate via network 330, which may include a conventional Ethernet network, the Internet or both. Server system 310 and user devices 320 each include a communication interface 410 and 510, respectively, each of which may include a conventional communication interface running suitable communication protocols, such as Ethernet, TCP/IP or both. In one embodiment, unless otherwise noted herein, all communication in and out of all systems 310 and 320 are made via each system's respective input/out 408 and 508 of its respective communication interface 410 and 510.

Referring now to FIG. 3, a user may register with a website in any conventional manner. In one embodiment, log in/registration manager 420 receives user registration information, such as a user identifier and corresponding password, and stores any such received registration information in user information storage 412. At any subsequent time, a registered user may log in to the website by providing such user identifier and corresponding password. In one embodiment, log in/registration manager 420 also receives and optionally authenticates such user log in information.

At any time after the user has registered and/or logged in, the user may provide profile characteristics and preference information, described above, and profile/preference manager 422 receives such information from the user and stores it in user information storage 414 associated with the user identifier corresponding to the user from which such information is received.

At any time, the registered and/or logged in user may also send and receive any messages and/or replies, such as e-mail messages, as described herein. In one embodiment, server mail delivery manager 424 receives any messages sent from a user to another user and stores such messages in server email storage 414 associated with the user identifier corresponding to the user sending the message, the user identifier corresponding to the intended recipient of the message, and the date and time when such message is sent by the sending user to the recipient user. Server mail delivery manager 424 may deliver any messages to its intended recipient in any conventional manner, such as by providing a notification link to the recipient user.

If the recipient user requests to view the received message, such as by clicking the notification link provided by server mail delivery manager 424 to view a received message, server mail delivery manager 424 receives such click, displays the message in a conventional manner, and marks the viewed message as “viewed” in server email storage 414. Server mail delivery manager 424 may also store in server email storage 414 the date and time when such message is first viewed by the recipient user.

The user may request to respond to the viewed message by providing a reply message, as described above, such as by clicking a reply link provided by server mail delivery manager 424. In one embodiment, if the user requests to reply to a received message, server mail delivery manager 424 receives the request and receives any reply message provided by the recipient user in response to the received message, as described above, and server mail delivery manager 424 may mark the message to which the recipient user has replied as “replied to” in server email storage 414, along with the date and time when the reply to such message was received from the recipient user.

Mail success determination manager 426 identifies any successful and unsuccessful messages, as described above, in server email storage 414. In one embodiment, to identify successful messages in server email storage 414, mail success determination manager 426 identifies any messages which have been viewed by the intended recipient of the message and have been replied to by such recipient user with a reply message of at least minimum length (e.g. at least ten words), and mail success determination manager 426 may mark such messages in server email storage 414 as successful messages.

To mark unsuccessful messages in server email storage 414, mail success determination manager 426 may identify messages which have been viewed by the recipient user of such message but have not been replied to with a reply message by the recipient user. In one embodiment, mail success determination manager 426 may also identify as unsuccessful any messages which have been replied to by the recipient user with only a courtesy message, such as a very short message which is not of minimum length stating “not interested” or any similar message, and mail success determination manager 426 may mark such messages as unsuccessful in server email storage 414. In one embodiment, when mail success determination manager 426 has marked successful and unsuccessful messages in server email storage 414, it signals user response time/selectivity manager 428.

User response time/selectivity manager 428 receives the signal from mail success determination manager 426 and identifies a standard response time, as described above, corresponding to each user receiving, viewing, and responding to any messages, and user response time/selectivity manager 428 also identifies a selectivity score corresponding to each such user, as described above. To identify the standard response time for a user receiving, viewing, and responding to any messages, for each message that is both viewed and responded to by the user (with a reply message of at least minimum length), user response time/selectivity manager 428 identifies the length of time between the date and time the message is viewed by the recipient user and the date and time when the reply message corresponding to such message is sent by the recipient user, as described above. In one embodiment, user response time/selectivity manager 428 may calculate the standard response time corresponding to a recipient user as the mean or average length of time that such recipient user takes to respond to a message, and user response time/selectivity manager 428 stores such standard response time calculated for each user in user information storage 412 associated with the user identifier for which each score is calculated.

In one embodiment, when user response time/selectivity manager 428 has identified a standard response time for a user, user response time/selectivity manager 428 may also identify any messages which have been marked as unsuccessful in server email storage 414 (i.e. messages which have not been replied to by the recipient user) and for which the standard response time identified for the recipient user of such message has not yet passed as described above, and user response time/selectivity manager 428 may unmark such messages as unsuccessful in server email storage 414. User response time/selectivity manager 428 may identify and unmark any number of such messages corresponding to any number of recipient users, as described above.

Additionally, user response time/selectivity manager 428 identifies a selectivity score corresponding to each user as described above and stores the selectivity score identified for each user in user information storage 412 associated with the user identifier corresponding to the user for which such score is calculated. In one embodiment, user response time/selectivity manager 428 identifies in server email storage 414 the number of messages received and/or viewed by each user, as well as the number (or percentage) of such received and/or viewed messages to which each user replies, and/or any other information corresponding to messages sent or received by users, to determine the selectivity score for each user as described above. When user response time/selectivity manager 428 has identified and stored the selectivity scores corresponding to each user in user information storage 412, it signals length analysis manager 430.

Length analysis manager 430 receives the signal from user response time/selectivity manager 428, and length analysis manager 430 analyzes the message length of successful and unsuccessful messages received by each user, and of successful and unsuccessful messages received by each pool of all users, as described above. In one embodiment, length analysis manager 430 may identify all the successful and unsuccessful messages in server email storage 414 associated with each recipient user identifier to analyze message length information corresponding to successful and unsuccessful messages received by each recipient user, including tallying helpful and unhelpful scores corresponding to one or more ranges of message lengths for the successful and unsuccessful message received by each user, as described above. To tally helpful and unhelpful scores corresponding to message length as described above for a pool of all users, which may be defined by region information and/or any other profile characteristics information corresponding to users as described above, length analysis manager 430 identifies successful and unsuccessful messages in server email storage 414 corresponding to each of any recipient users associated included in such pool of all users, for which the selectivity score stored corresponding to each of such users in user information storage 412 is included in the acceptable range of selectivity scores, as described above. Length analysis manager 430 analyzes the message length corresponding to such messages to identify helpful and unhelpful scores corresponding to each range of message lengths defined as described above.

In one embodiment, length analysis manager 430 stores any helpful and unhelpful scores determined corresponding to each range of message lengths in server email statistics storage 416 associated with the user identifier for which such scores are determined or the region identifier, which may be one or more profile characteristics associated with the pool of recipient users, for which each set of helpful and unhelpful scores for all users are determined.

As described herein, any element calculating and storing helpful and unhelpful scores corresponding to any message component for each user and for each region or pool of all users may identify successful and unsuccessful messages in server email storage 414 in a manner similar to the manner length analysis manager 430 identifies such messages, and may store any calculated helpful and unhelpful scores in server email statistics storage 416 in a manner similar to the manner length analysis manager 430 stores such scores calculated for each user and for all users corresponding to message length. In one embodiment, length analysis manager 430 signals type analysis manager 432.

Type analysis manager 432 receives the signal from length analysis manager 430, and type analysis manager 432 analyzes message type information, including identifying helpful and unhelpful scores corresponding to each message type described above, for successful and unsuccessful messages received by each user and received by each pool of all users. In one embodiment, type analysis manager 432 may identify profile characteristics information and preference information corresponding to any sending user and/or recipient user in user information storage 412. In one embodiment, type analysis manager 432 stores any such identified scores in server email statistics storage 416, each associated with the appropriate user identifier and/or region identifier. Type analysis manager 432 may signal word analysis manager 434.

Word analysis manager 434 receives the signal and analyzes messages words included in each successful and unsuccessful message received by each recipient user, and also analyzes messages words included in each successful and unsuccessful message received by each pool of all users as described above. In one embodiment, word analysis manager 434 may identify helpful and unhelpful scores corresponding to any number of messages words as described above, and word analysis manager 434 stores such helpful and unhelpful scores in server email statistics storage 416 associated with the user identifier corresponding to each recipient user for which the scores are determined, or associated with the region identifier corresponding to each pool of all users for which scores are determined, as described above.

Word analysis manager 434 signals phrase analysis manager 436, which receives the signal and identifies helpful and unhelpful scores corresponding to any number of message phrases in the manner described above, with respect to successful and unsuccessful messages received by each user, as well as the successful and unsuccessful messages received by each pool of all users as described above. In one embodiment, phrase analysis manager 436 stores each of such helpful and unhelpful scores in server email statistics storage 416 associated with the recipient user identifier for which the scores are determined, or associated with the region identifier corresponding to each pool of all users for which the scores are determined, and phrase analysis manager 436 signals weights manager 438, which receives the signal.

Weights manager 438 assigns one or more weights to the helpful and unhelpful scores stored corresponding to each message component, including message length, type, words, and phrases, for which helpful and unhelpful scores have been calculated and stored for each user, and for each pool of all users, as described above, and weights manager 438 determines any number of success indicator thresholds as described above. In one embodiment, weights manager 438 identifies helpful and unhelpful scores for each message component corresponding to each message component, with respect to each recipient user identifier in server email statistics storage 416, and weights manager 438 determines weights corresponding to each of the messages components with respect to each user as described above. In one embodiment, weights manager 438 determines a success indicator score for each successful and unsuccessful message using the helpful and unhelpful scores corresponding to each of the message components included in each message, and weights manager 438 uses regression analysis to maximize the success indicator score, described in more detail above and below, calculated for successful messages received by each user and each pool of all users and minimize the success indicator score calculated for unsuccessful messages received by each user.

Weights manager 438 also identifies helpful and unhelpful scores corresponding to each pool of all users in server email statistics storage 416 to determine the weights corresponding to each of the message components with respect to each pool of all users as described above. In one embodiment, weights manager 438 uses regression analysis to maximize the success indicator score, described in more detail above and below, calculated for successful messages received by each pool of all users and minimize the success indicator score calculated for unsuccessful messages received by each pool of all users. Weights manager 438 stores any such weights calculated in server email statistics storage 416 associated with the user identifier or region identifier for which the weights are calculated.

In one embodiment, when weights manager 438 has identified and stored weights corresponding to message components for each user and for each pool of all users as described above, weights manager 438 identifies one or more success indicator score thresholds which may be used to define one or more success indicator ranges as described above. Weights manager 438 stores the success indicator score thresholds in server email statistics storage 416.

At any time using a user device 310, a user may request to send a message to another user, or the user may request to send a reply message to a message received by the user, as described above, such as by clicking a link to send a message provided by message user interface manager 522. In one embodiment, the user requesting to send the message, or the sending user, may click a link requesting to send a message, which includes the user identifier corresponding to the intended recipient of the user's requested message, or the user may provide the user identifier corresponding to the intended recipient, such as by typing the user identifier of the intended recipient in a “to:” field provided by message user interface manager 522. In one embodiment, message user interface manager 522 receives the user's request, along with the user identifier of the intended recipient (“recipient user identifier”) of the user's requested message, and message user interface manager 522 provides such recipient user identifier to device up/download manager 540 along with a request to download data and weights information corresponding to such recipient user identifier.

Device up/download manager 540 receives the recipient user identifier and request from message user interface manager 522, and device up/download manager 540 signals server up/download manager 440 with the user identifier of the intended recipient and requests to download data and weights information for message length, type, words, and phrases with respect to such user identifier, as well as with respect to the pool of all users corresponding to the user identifier.

In one embodiment, device up/download manager 540 may also provide the user identifier corresponding to the user requesting to send the message (“sending user identifier”) to server up/download manager 440. Server up/download manager 440 receives the recipient user identifier, sending user identifier, and request to download data and weights information corresponding to the recipient user identifier from device up/download manager 540, and server up/download manager 440 identifies the data and weights information in server email statistics storage 416 associated with the received recipient user identifier. In one embodiment, for any communications between device up/download manager 440 and server up/download manager 540, device up/download manager 440 may provide an encrypted version of any user identifier it provides to server up/download manager 540, which server up/download manager 540 decrypts, and vice versa.

In one embodiment, server up/download manager 440 also identifies one or more selectivity scores, described above, associated with the received recipient user identifier in user information storage 412. Server up/download manager 440 provides such selectivity score or scores and the requested data and weights information to device up/download manager 540 in response to the request received, and device up/download manager 540 receives the provided information.

Server up/download manager 440 may also identify any profile characteristics corresponding to the received user identifier in user information storage 412 which are associated with any pools of all users, such as the user's location information or other region information. Server up/download manager 440 identifies data and weights information corresponding to such region information in server email statistics storage 416 and checks the date and time such data and weights information was provided to device up/download manager 540 corresponding to the received sending user identifier. If such data and weights information has never been provided, or has not been provided recently within a threshold amount of time, to device up/download manager 540 corresponding to the received sending user identifier, then server up/download manager 440 additionally provides such data and weights information corresponding to the recipient user's region or pool of all users to device up/download manager 540. Server up/download manager 540 may also provide any success indicator score thresholds stored in server email statistics storage 416 as described above to device up/download manager 540.

In one embodiment, if the data and weights corresponding to the intended recipient user's pool of all users has been previously downloaded within the threshold amount of time, server up/download manager 440 may not provide such information to device up/download manager 540 at this time.

In one embodiment, server up/download manager 440 stores the date and time when data and weights information corresponding to any pool of all users is provided to device up/download manager 540 in server email statistics storage 416, along with the sending user identifier it received corresponding to the user for which such information is provided.

In one embodiment, server up/download manager 440 may also identify any profile characteristics associated with the sending user identifier in user information storage 412 which are similar to any profile characteristics associated with the recipient user identifier and/or which are compatible with any preference information associated with the recipient user identifier, as described above. Server up/download manager 440 may provide any such common profile characteristics information and/or compatible preference information to device up/download manager 540, and server up/download manager 440 may also provide the selectivity score associated with the recipient user identifier

Device up/download manager 540 receives any data and weights information, selectivity score or scores, any success indicator score thresholds information and/or common profile characteristics or compatible preference information, provided by server up/downloaded manager 440 and stores such received information in device statistics storage 512. In one embodiment, device up/download manager 540 stores the data and weights information corresponding to the recipient user, the recipient user's selectivity score or scores, and any common profile characteristics and/or compatible preference information received in device statistics storage 514 associated with the user identifier of the intended recipient, and device up/download manager 540 stores the data and weights information corresponding to the recipient user's pool of all users in device statistics storage 512 associated with the one or more profile characteristics defining such pool of all users or any other region identifier. Device up/download manager 540 may store any success indicator threshold scores in device statistics storage 512 associated with the date and time such scores are received.

The user may take any number of actions with respect to the requested message, such as typing messages words into a message space provided by message user interface manager 522, requesting hints corresponding to the message, or requesting to send the message, as described above. If the user types messages any message words and/or phrases into the message space provided by message user interface manager 522 as described above, message user interface manager 522 receives such typed words, stores the received words in device storage 514, and signals message score manager 524. In one embodiment, message user interface manager 522 may store message words in device message storage 514 associated with the user identifier corresponding to the recipient user and a message identifier, and message user interface manager 522 may signal message score manager 524 with such message identifier.

Message score manager 524 receives the signal and message identifier from message user interface manager 522, and message score manager 524 determines a display indicator score corresponding to such message as described above. In one embodiment, message score manager 524 may determine one or more success indicator scores using the data and weights corresponding to the recipient user identifier in device statistics storage 514 and using the data and weights corresponding to the pool of all users associated with the recipient user identifier in device statistics storage 512. Message score manager 524 identifies the length and type of the message corresponding to the received message identifier in device message storage 514, and identifies the weighted helpful and unhelpful scores corresponding to such identified message length and type in device statistics storage 512. Message score manager 524 also identifies any number of weighted helpful and unhelpful scores corresponding to any message words and/or phrases identified in such message and identifies the corresponding weighted helpful and unhelpful scores in device statistics storage 512 associated with any such message words and/or phrases.

To determine the display indicator score as described above, message score manager 524 may identify one or more similarity weights corresponding to any set of data and weights used to determine a success indicator score for the user's message, such as the set of data and weights corresponding to the recipient user identifier and the set of data and weights corresponding to the recipient user's pool of all users, and message score manager 524 multiplies each success indicator score determined with the similarity weight assigned to the set of data and weights used to determine each score, as described above. Message score manager 524 sums the weighted success indicator scores to determine a display indicator score corresponding to the user's message with respect to the intended recipient of such message.

In one embodiment, message score manager 524 may identify the selectivity score or scores stored corresponding to the recipient user identifier in device statistics storage 512 and multiply the display indicator score calculated times a multiplier based on such selectivity score or scores identified as described above. In one embodiment, message score manager 524 stores the weighted display indicator score in device message storage 514 associated with the user's current message and signals message user interface manager 522 to display a success indicator corresponding to the user's message as described above.

Message user interface manager 522 receives signal from message score manager 523 and identifies the weighted display indicator score corresponding to the user's message in device message storage 514. In one embodiment, message user interface manager 522 compares the weighted display indicator score identified with the one or more success indicator score thresholds stored in device statistics storage 512, identifies the display range which includes such weighted display indicator score displays one or more colored bars, such as red or green bars as described above, indicating the likelihood of the user's message receiving a reply from the recipient user.

At any time, the user may request one or more hints or suggestions for the user's message with respect to any of the message components described herein, such as by clicking a user interface control to request such hints, or rolling the user's pointing device over a user interface control to display a hint, which may be provided by message user interface manager 522. If the user clicks or rolls over the user interface control to request hints, message user interface manager 522 receives the request and signals message hint manager 526 to display any hints corresponding to message length, type, words, and/or phrases for the user's message as described above. Message hint manager 526 receives the signal, and message hint manager 526 identifies any suggestions corresponding to message length, type, words, and/or phrases to increase the display indicator score for the user's message as described above. In one embodiment, to display any suggestions identified corresponding to message length and message type, message hint manager 526 may display a new window, such as a pop-up window, over the window used by message user interface manager 522 to display the user's message.

To identify any length correction information corresponding to the user's message, message hint manager 526 may identify the length of the message stored in device message storage 514 and identify the range of message lengths that would contribute most positively to the weighted display indicator score calculated for the user's message. Message hint manager 526 may identify the range for message length for which the sum of the weighted helpful and unhelpful scores for message length in device statistics storage 512 is greatest corresponding to messages received by the recipient user and to messages received by the pool of all users associated with the recipient user. Message hint manager 526 compares the message length of the user's message with such identified range of message lengths and provides a suggestion corresponding to the message length of the user's message to increase the display indicator score corresponding to the user's message. In one embodiment, message hint manager 526 may display an indication whether to increase or decrease the length of the user's message, such as “too short” or “too long”.

To identify suggestions corresponding to message type, message hint manager 526 may identify the message type identified in the highest percentage of successful messages received by the intended recipient of the user's message using the data and weights corresponding to the recipient user in device statistics storage 512. Message hint manager 526 may identify any common profile characteristics and/or compatible preference information shared by the sending user and the recipient user which stored in device statistics storage 512, and message hint manager 526 may display such common profile characteristics and/or compatible preference information to the user. At any time, the user may click a user interface control provided by message hint manager 526 to close any pop-up window used to display suggestions corresponding to the user's message, and if the user clicks such user interface control, message hint manager 526 receives the click and discontinues displaying the pop-up window as requested.

In one embodiment, to display hints corresponding to message words and/or phrases, message hint manager 526 may identify any words and/or phrases included in the user's message in device message storage 514 which contribute negatively to the weighted display indicator score corresponding to such message, which may include the message words and/or phrases in device statistics storage 512 for which the sum of the weighted helpful and unhelpful scores, with respect to the recipient user as well as to the recipient user's pool of all users, is the most negative. Message hint manager 526 may highlight such negatively contributing words and/or phrases as such in the user's message, such as by highlighting the unhelpful words and/or phrases in red as described above.

The user may add, delete, or change any message words, such as by using any hints displayed by message hint manager 526 or using the success indicator displayed by message user interface manager 522, and message user interface manager 522 receives any such additions, deletions, or changes to message words and may signal message score manager 524 to calculate a weighted display indicator score corresponding to the user's message at any time.

If the user requests to send the user's message, such as by clicking a send link provided by message user interface manager 522, then message user interface manager 522 receives such click and signals device up/download manager 540 with the message identifier corresponding to the user's message in device message storage 514 to upload the message corresponding to such message identifier from device message storage 514. Device up/download manager 540 receives the signal and message identifier, and device up/download manager 540 retrieves and provides the message corresponding to the received message identifier in device message storage 514 to server up/download manager 440 along with the user identifier corresponding to the user sending the message and the user identifier corresponding to the intended recipient of the message, both of which may be encrypted.

Server up/download manager 440 receives the message from device up/download manger 540, along with the sending user identifier and recipient user identifier, and server up/download manager 440 may provide such received message, sending user identifier, and recipient user identifier to server mail delivery manager 424, which receives the information from server up/download manager 440 and stores the user's message in server email storage 414 associated with a server message identifier, the sending user identifier, recipient user identifier, and date and time when such message was received, as described above. Server mail delivery manager 424 delivers any messages received and stored in server email storage 414 in a conventional manner as described above.

1. A method of indicating a likelihood of a response being subsequently received to a message electronically being prepared for sending by a first user to a second user, the method comprising:
receiving at least one characteristic of a plurality of users comprising the second user;
identifying a subset of users in the plurality of users responsive to having at least one of the at least one characteristic shared with the second user;
identifying a score for each of a plurality of characteristics of a plurality of messages that have been received by the subset of users to which the user receiving the message sent a response, the score indicating a likelihood that a message with the corresponding characteristic was sent a response;
identifying any of the characteristics in the message being prepared for sending by the first user to the second user;
computing a success score for the message being prepared for sending by the first user to the second user responsive to the any of the characteristics identified and the identified score for any such identified characteristics; and
displaying an indicator responsive to the success score computed.

2. The method of claim 1, wherein at least one of the plurality of characteristics of the plurality of messages used to compute the success score comprises message length.

3. The method of claim 1 wherein at least one of the at least one characteristic of the plurality of uses used to identify the subset of users comprises a location.

4. The method of claim 1, wherein the subset of users in the plurality is identified additionally responsive to a message response rate of each user.

5. The method of claim 1 wherein the score is identified responsive to the response having at least one characteristic of the response.

6. The method of claim 5 wherein at least one of the at least one characteristic of the response comprises a length.

7. The method of claim 1, wherein:
the success score is computed multiple times using the state of the message at such time, as the first user is in the process of typing the message; and
the indicator is displayed responsive to each time the success score is computed.

8. A system for indicating a likelihood of a response being subsequently received to a message electronically being prepared for sending by a first user to a second user, the system comprising:
a profile/preference manager having an input for receiving at least one characteristic of a plurality of users comprising the second user, the profile/preference manager for providing the at least one characteristic received for each of the plurality of users at an output;
an upload/download manager having an input coupled to the profile/preference manager output for receiving the at least one characteristic of at least the second user, the upload/download manager for identifying a subset of users in the plurality of users responsive to having at least one of the at least one characteristic shared with the second user, and for providing at an output an indication of the subset of users identified;
at least one analysis manager having an input coupled for receiving a plurality of messages that have been received by the subset of users to which the user receiving the message sent a response, the at least one analysis manager for identifying and providing at an output a score for each of the plurality of characteristics of a plurality of messages that have been received by the subset of users to which the user receiving the message sent a response, the score indicating a likelihood that a message with the corresponding characteristic was sent a response;
a user interface manager having an input for receiving the message electronically being prepared for sending, the user interface manager for identifying any of the characteristics in the message being prepared for sending by the first user to the second user and for providing at an output an indication of each of the characteristics identified;
a message score manager having an input coupled to the user interface manager for receiving the indication of the any of the characteristics identified, and coupled to the at least one analysis manager output for receiving the score for each of the plurality of characteristics and to the user interface manager output for receiving the indication of each of the characteristics identified, the message score manager for computing and providing at an output a success score for the message being prepared for sending by the first user to the second user responsive to each of the characteristics identified and the identified score for any such identified characteristics; and
the user interface manager input additionally coupled to the message score manager output for receiving the success score, the user interface manager additionally for displaying an indicator responsive to the success score computed.

9. The system of claim 8, wherein at least one of the plurality of characteristics of the plurality of messages used to compute the success score comprises message length.

10. The system of claim 8 wherein at least one of the at least one characteristic of the plurality of uses used to identify the subset of users comprises a location.

11. The system of claim 8, wherein the subset of users in the plurality is identified additionally responsive to a message response rate of each user.

12. The system of claim 8 wherein the score is identified responsive to the response having at least one characteristic of the response.

13. The system of claim 12 wherein at least one of the at least one characteristic of the response comprises a length.

14. The system of claim 8, wherein:
the message score manager computes and provides at the message score manager output a at least one different additional version of the success score computed as described in claim 8 but corresponding to the state of the message at different times as the first user is typing the message;
the user interface manager input is additionally for receiving the at least one different additional version of the success score and
the user interface manager displays the indicator additionally responsive to each different additional version of the success score received.

15. A computer program product comprising a computer useable medium having computer readable program code embodied therein for indicating a likelihood of a response being subsequently received to a message electronically being prepared for sending by a first user to a second user, the computer program product comprising computer readable program code devices configured to cause a computer system to:
receive at least one characteristic of a plurality of users comprising the second user;
identify a subset of users in the plurality of users responsive to having at least one of the at least one characteristic shared with the second user;
identify a score for each of a plurality of characteristics of a plurality of messages that have been received by the subset of users to which the user receiving the message sent a response, the score indicating a likelihood that a message with the corresponding characteristic was sent a response;
identify any of the characteristics in the message being prepared for sending by the first user to the second user;
compute a success score for the message being prepared for sending by the first user to the second user responsive to the any of the characteristics identified and the identified score for any such identified characteristics; and
display an indicator responsive to the success score computed.

16. The computer program product of claim 15, wherein at least one of the plurality of characteristics of the plurality of messages used to compute the success score comprises message length.

17. The computer program product of claim 15 wherein at least one of the at least one characteristic of the plurality of uses used to identify the subset of users comprises a location.

18. The computer program product of claim 15, wherein the subset of users in the plurality is identified additionally responsive to a message response rate of each user.

19. The computer program product of claim 15 wherein the score is identified responsive to the response having at least one characteristic of the response.

20. The computer program product of claim 19 wherein at least one of the at least one characteristic of the response comprises a length.

21. The computer program product of claim 15, wherein:
the success score is computed at multiple different times using the state of the message at such time, as the first user is typing the message; and
the indicator is displayed responsive to each time the success score is computed.
